(19) United States
(12) Patent Application Publication
(10) Pub. No.: US 2008/0309067 A1
(43) Pub. Date: Dec. 18, 2008

(54) Repair pipe fittings

(76) Inventor: William B. Fazakerly, Pleasanton, CA (US)

Correspondence Address: William B. Fazakerly, 4967 Dolores Drive, Pleasanton, CA, 94566, US

(21) Appl. No.: 11/818,154

(22) Filed: Jun. 14, 2007

(51) Int. Cl. F16L 55/18

(52) U.S. Cl. 285/15

(57) ABSTRACT

Disclosed is a pipe fitting specifically designed for repair applications called a Repair Pipe Fitting. One or more of the arms (inlets or outlets) of a Repair Pipe Fitting is longer than the corresponding arm on a standard pipe fitting, so that connecting pipes that have been cut to remove a standard pipe fitting do not have to be extended to install a Repair Pipe Fitting. Repair pipe fittings are best suited for use with plastic pipe, where joints are sealed with cement, although Repair Pipe Fittings may also be used with metal pipe, where joints are sealed with welds or threads. Repair pipe fittings may be sealed using the same sealing method as used by the original fittings, such as cement for plastic fittings and pipes. Repair pipe fittings may also be sealed using a non-permanent sealing method such as compression caps and gaskets.

### CROSS REFERENCE TO RELATED APPLICATIONS

None

### STATEMENT REGARDING FEDERALLY SPONSORED RESEARCH

None

### REFERENCE TO SEQUENCE LISTING OR PROGRAM LISTING

None

### BACKGROUND OF THE INVENTION

The present invention applies to drainage systems, sprinkler systems, pool water filtration systems, and other plumbing systems that use pipes to transport fluid. The pipes and components of such plumbing systems are assembled using pipe fittings such as tees and elbows. These fittings allow pipes to be coupled together, redirected, and connected to drains, valves, sprinkler heads and other items for controlling the flow and delivery of fluid. After such a plumbing system is assembled, the replacement of an installed fitting is quite difficult since an installed fitting must be cut out of the system and cannot be directly replaced by a duplicate fitting without some amount of system modification and repair. This problem affects metal plumbing systems that are assembled with threaded fittings, since pipes and fittings cannot be unthreaded from any internal point. The problem also affects plastic plumbing systems that are assembled using a glue or cement that creates a semi-permanent or permanent bond between pipes and pipe fittings. In either case, repair of a defective pipe fitting or other component at a location internal to the plumbing system will require that pipes be cut to remove the installed pipe fitting and subsequently lengthened to allow insertion of a replacement pipe fitting. Often, access to an installed fitting is limited due to nearby pipes or other obstacles, and in the case of buried or hidden pipes, access may require excavation or other material removal.

The difficulty of repairing installed pipe fittings is well known, and prior art attempts to address this problem include multi-piece fittings or sleeves designed to be assembled around connecting pipes or fittings to form mechanical seals such as disclosed in U.S. Pat. Nos. 3,517,701, 3,771,820, 3,944,260, 4,889,370, and 4,109,944. Other prior art includes multi-piece fittings designed to be heat welded around connecting pipes as disclosed in U.S. Pat. No. 6,237,640. Other prior art includes multi-piece fittings with sliding sleeves or telescoping members such as disclosed in U.S. Pat. Nos. 6,318,761, 5,975,587, 4,858,958, 3,857,588 and 4,035,002. Each of these prior art approaches involve multi-piece assemblies, internal seals, field heat welding, or moving parts. Cost and complexity has precluded their widespread usage. Related prior art addresses failures in the pipe itself, as opposed to defective fittings, such as disclosed in U.S. Pat. Nos. 4,386,796 and 5,443,096.

The present invention is a new kind of pipe fitting that is specifically designed for repair applications. Although simple in concept, these Repair Pipe Fittings (also called Repair Fittings) minimize the amount of material removal, the number of components, the amount of disassembly and assembly, and the amount of labor that is required to replace an installed pipe fitting that is internal to a plumbing system.

### BRIEF SUMMARY OF THE INVENTION

To remove an installed pipe fitting, all of the pipes connecting to the installed fitting must be cut. Even if these connecting pipes are cut as dose to the edges of the installed fitting as possible, the connecting pipes cannot be bridged by a new pipe fitting identical to the installed fitting because, after cutting out the installed fitting, the connecting pipes are too short to be inserted into a replacement fitting that is identical to the installed fitting. So, using standard fittings, replacement of a defective fitting requires further exposure of all connecting pipes so that they can be lengthened with couplings and pipe stubs so that the replacement fitting may be inserted. On the other hand, a Repair Pipe Fitting is a one-to-one replacement of a standard fitting that has been removed from a plumbing system. The arms (inlets and outlets) of a Repair Pipe Fitting are extended to allow adequate insertion of the pipe that is exposed after a defective fitting has been removed, thereby eliminating the need to extend the connecting pipes with couplings and stubs.

Replacement of a defective fitting using a Repair Pipe Fitting offers advantages over repair with a standard fitting. Repair pipe fittings reduce the amount of excavation required at the point of repair because connecting pipes do not need to be exposed for the addition of couplings and stubs. Because the connecting pipes do not have couplings added, they remain more flexible and easier to insert into the Repair Fitting. Repair cost is reduced through the use of Repair Pipe Fittings since the connecting pipes do not require extension: Repair Fittings eliminate the time to measure, cut pipe stubs and glue couplings, as well as the cost of the additional couplings and pipe. Repair Pipe Fittings can eliminate significant time and cost in those cases where an entire subsystem would otherwise need to be replaced due to access limitation at the point of failure.

Repair Pipe Fittings also increase the reliability of the repaired plumbing system. Joints are the most likely failure points in a plumbing system. Joint failures are not always apparent when the system is initially tested: they often manifest themselves as slow leaks after the repair has been completed and the system is in use. When replacement of a plastic pipe fitting is done in a confined space, the probability of a joint failure is increased since it is more difficult to apply cement to the entire pipe circumference, and it takes more time between application of cement and insertion of the pipe into the fitting since movement of connecting pipes is restricted. Moreover, it takes two additional joints to extend a cut pipe: one at each end of the straight coupling. A Repair Pipe Fitting reduces the number of joints in the repair by a factor of three.

### BRIEF DESCRIPTION OF THE SEVERAL VIEWS OF THE DRAWING

FIG. 1. ¾″ 90° Elbow Glued in Place shows a cracked 90° elbow glued in place. As shown, an approximately 1.0 inch length of each connecting pipe is glued into the elbow.

FIG. 2. ¾″ 90° Elbow Repair using Repair Elbow shows a 90° Repair Elbow glued in place. The Repair Elbow extends about 0.8″ beyond the ends of the original elbow allowing adequate insertion of the connecting pipes.

FIG. 3. ¾″ 90° Elbow Repair using Standard Fittings shows a prior art repair using pipe stubs and straight couplings to allow a new elbow to be used in place of the old, cracked elbow.

FIG. 4. Repair fittings Reduce the Required Access Space for Repair shows two elbow repairs in process to illustrate the reduction in access space required to use a Repair Pipe Fitting. This figure shows couplings and stubs as part of a replacement assembly.

FIG. 5. Standard ¾ 90° Elbow—Cross Section shows a dimensioned cross section of a typical standard elbow. Insertion stops are noted in the Figure.

FIG. 6. ¾ 90° Repair Elbow—Cross Section shows a dimensioned cross section of a ¾ 90° Repair Elbow. Insertion stops are noted in the Figure.

FIG. 7. Standard ¾″ Reducing Tee—Cross Section shows a dimensioned cross section of a typical standard reducing tee.

FIG. 8. ¾″ Reducing Repair Tee—Cross Section shows a dimensioned cross section of a ¾″ Reducing Repair Tee.

FIG. 9. ¾″ Reducing Repair Tee with Gaskets shows an alternate approach for reconnecting cut pipes without the use of glue. This Repair Pipe Fitting is only usable in lower pressure applications such as non-line side sprinkler systems.

### DETAILED DESCRIPTION OF THE INVENTION

The present invention may be used in the repair of any plumbing system where pipes are glued, threaded or otherwise bonded into fittings. Such systems normally use pipe and fittings manufactured from plastics such as PVC (Poly-Vinyl Chloride) or ABS (Acrylonitrile-Butadiene-Styrene) with fittings manufactured from similar materials. These systems are used for drainage, lawn sprinklers, pool water circulation, and other similar applications. It is common for the fittings (e.g. tees or elbows) that are used to connect pipes, valves, and other components to fail after years of service. These failures include cracking of the fitting body, splitting of seams, stripping of threads, and leaking at joints. Moreover, failure of other system components may require replacement of fittings. When these failures occur, the installed pipe fitting must be cut out of the plumbing system.

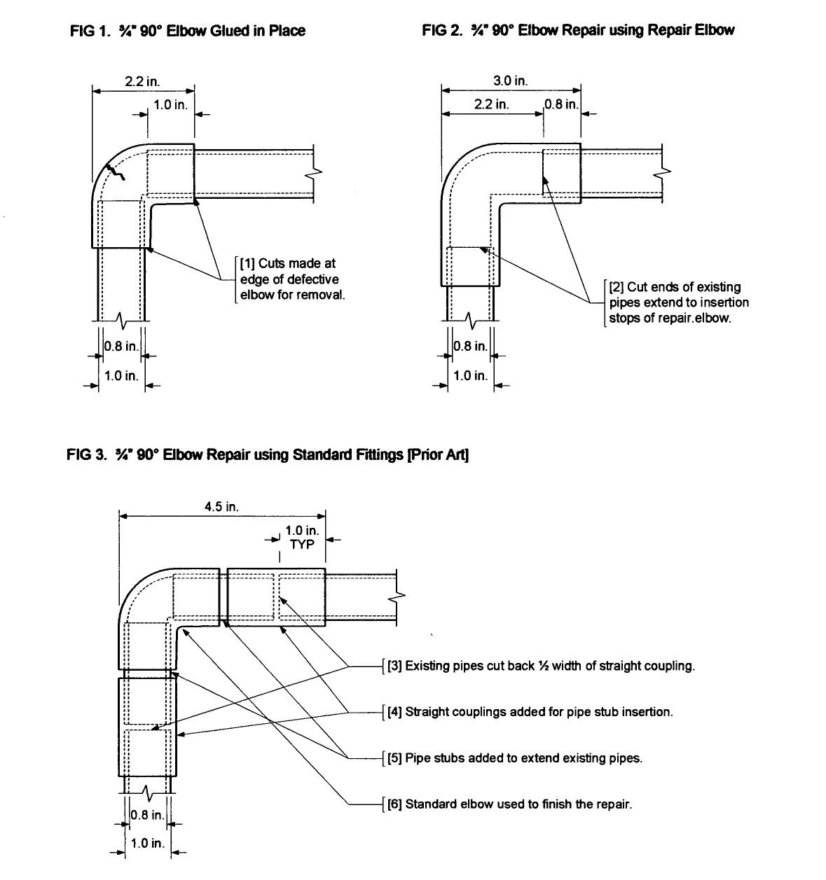

FIG. 1 shows an installed elbow with a crack. FIG. 1, Note [1] indicates that cuts must be made close to the edge of the installed fitting to allow use of a Repair Pipe Fitting. Removal of an installed pipe fitting also requires removal of the pipe ends that are glued into the fitting. As shown in FIG. 1, approximately 1 inch of PVC is normally glued into a standard pipe fitting; after this length of pipe is removed, it is impossible to insert a single standard fitting in the location where the defective fitting has been removed. After removal of an installed fitting, the remaining pipe segments are too short to accommodate a new pipe fitting that is the same size as the pipe fitting that was removed.

FIG. 2 shows the pipes of FIG. 1 with a 90° Repair Elbow glued into the exact place where the defective elbow of FIG. 1 was removed. Note that each arm of the Repair Elbow is longer than the corresponding arm of the defective elbow by an amount sufficient to allow adequate insertion of the pipes that were cut to remove the defective elbow. In FIG. 2, this additional length is shown as 0.8″, so that the overall length of each arm of the Repair Elbow is 3.0″, while the overall length of each arm on the defective elbow is 2.2″. FIG. 2, Note [2] shows the insertion stop point for pipes inserted into the Repair Elbow is 2.2″ from the outside of the Repair Elbow, which is the overall size of the standard fitting. It should be understood that the principles illustrated by the 90° Repair Elbow in FIG. 2 apply equally well to 45° elbows, couplings, tees and other types of fittings.

FIG. 3 illustrates the prior art repair process for the defective elbow of FIG. 1 using standard fittings. Normally, a defective pipe fitting is replaced by an assembly comprising a new fitting with a pipe stub and straight coupling for each of the arms. To replace the defective elbow of FIG. 1, connecting pipes must be cut back from the installed pipe fitting approximately one-half the width of a straight coupling as indicated by Note [3]. Straight couplings, indicated by Note [4], must be glued onto each of the cut back pipes. Pipe stubs of the approximate length of a straight coupling must be glued into the couplings as indicated by Note [5]. Finally, the standard elbow may be glued onto the pipe stubs as indicated by Note [6]. The final assembly of FIG. 3 comprises an elbow, two straight couplings and two pipe stubs, and the overall length of each arm of the assembly (4.5″) is approximately twice the length of the corresponding arm on the original fitting (2.2″). Note that the Repair Elbow shown in FIG. 2 is significantly smaller than the replacement assembly shown in FIG. 3.

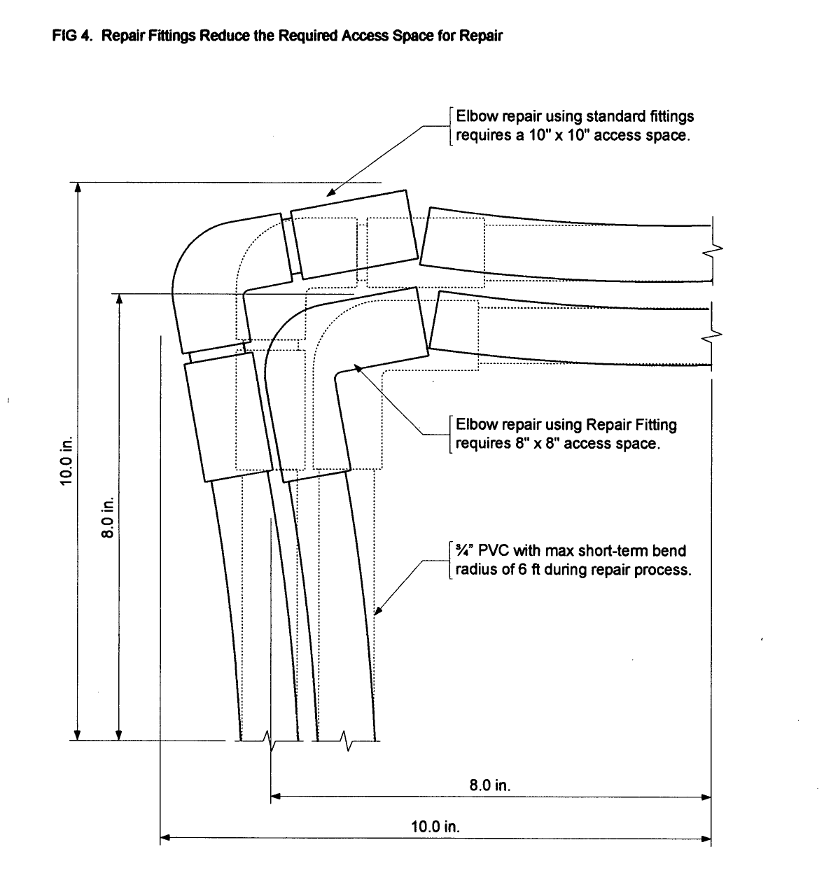

Pipe segments are less flexible after the addition of couplings, making insertion of the replacement assembly, or the insertion of the final component, more difficult. As shown in FIG. 4, the access space required to allow pipe flexing and insertion of a Repair Pipe Fining is reduced from the space that is required to insert a prior art replacement assembly using standard fittings. FIG. 4 shows ¾″ Schedule 40 pipe which cannot be easily bent with less than a 6 foot radius. As shown, the Repair Elbow reduces the required access for repair by approximately 20%, which is often sufficient to eliminate a significant amount of excavation work and movement of nearby obstacles. FIG. 4 shows the replacement assembly as a unit, although the couplings and stubs are usually glued onto the pipes before the replacement fitting. The precise order of assembly of the prior art repair varies depending on the access space and obstructions encountered during the repair.

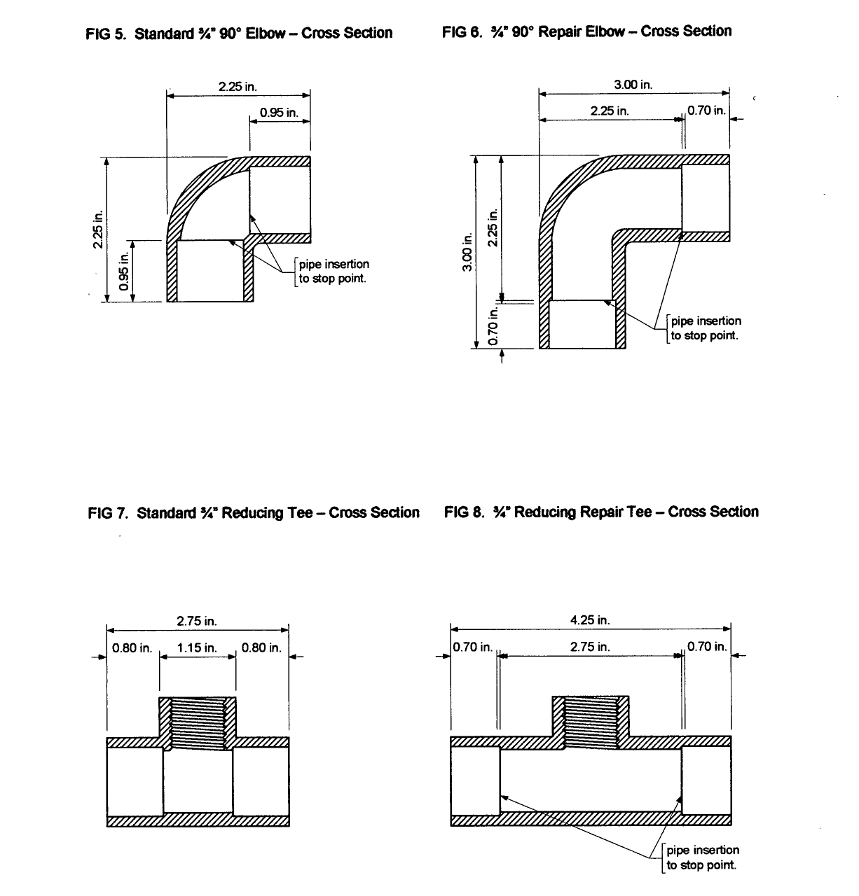

A cross section view of a standard ¾″ 90° elbow is shown in FIG. 5. Overall size is 2.25″ square with accommodation for 0.95″ insertion depth. (There is some variation in the size and insertion depth across manufacturers, but not enough to impact the utility of the present invention.) A cross section of the 90° repair elbow is shown in FIG. 6. The repair elbow extends 0.75″ beyond the edge of the standard elbow, which allows approximately 0.70″ insertion depth for the cut pipe, assuming 0.05″ of material is removed by the cutting tool when the defective elbow is cut out. Typical standard fittings are designed for insertion depths ranging from 0.70″ on short tees to 1.00″ on standard elbows and tees. A full 0.70″ insertion that is properly primed and cemented will be suitable for pressure-side application.

FIG. 7 and FIG. 8 show dimensioned cross section views of a standard reducing tee and a Reducing Repair Tee. Reducing tees with threaded ports are commonly used for sprinkler head risers. When a sprinkler head is forcibly broken off, it is possible for the riser to break off inside of the tee or for the tee to crack. The Reducing Repair Tee of FIG. 8 can be used to replace a cracked tee or a tee with stripped or otherwise unusable threads.

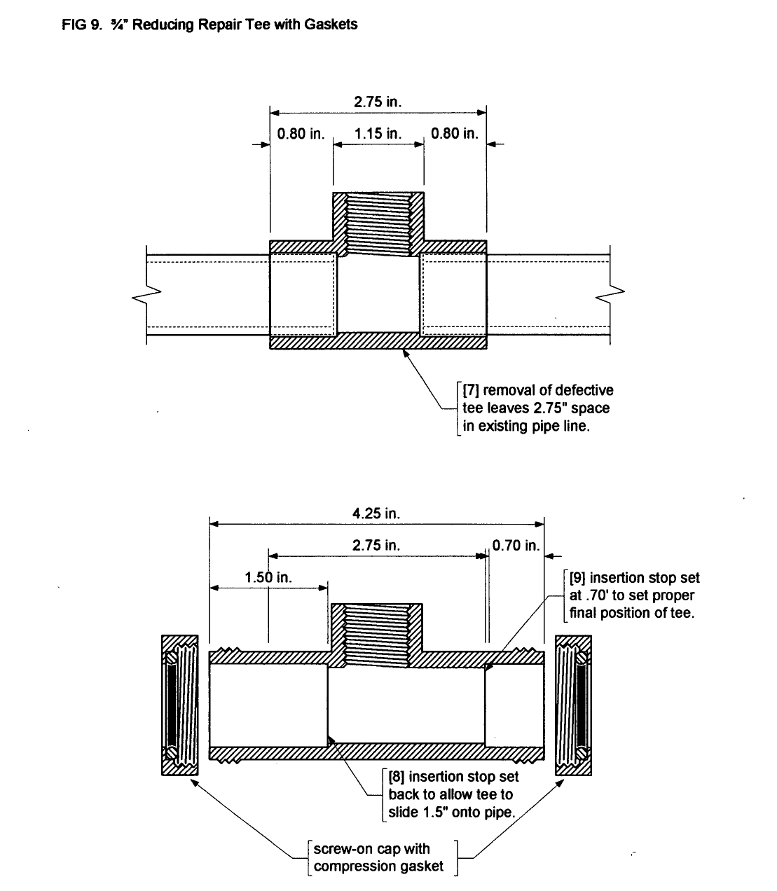

FIG. 9 shows a standard reducing tee, as normally used for sprinkler heads, above a variation of the Repair Tee. The Repair Tee in FIG. 9 uses screw-on caps to compress gaskets against the outside diameter of the inserted pipe. This type of fitting eliminates the glue or cement, and is suitable for non-pressure-side applications such as replacement of sprinkler head tees. As indicated by Note [7], the removal of a standard tee leaves a 2.75″ space in the pipe line, and the Repair Tee with gaskets is designed to bridge this gap. One end of the Repair Tee allows pipe insertion to approximately twice the final insertion depth so that the Repair Tee may be slid onto the connecting pipe in one direction, per Note [8], before being placed over the opposite pipe and slid into its final position as set by the stop indicated by Note [9]. Compression caps and o-ring gaskets are well known prior art; however, the use of these items in a Repair Tee as shown in FIG. 9 depends upon the extension and threading of the arms and proper design of the insertion depth stops as claimed by the present invention. The threaded cap and o-rings are shown in FIG. 9 to clarify the use of the Threaded Repair Tee.

Although the figures referenced in this patent have shown ¾″ PVC (Poly-Vinyl Chloride) pipe, the benefits of Repair Pipe Fittings are equally applicable to all other pipe sizes and to other material types including, but not limited to, ABS (Acrylonitrile-Butadiene-Styrene), CPVC (Chlorinated Poly-Vinyl Chloride), PE (Polyethylene), steel, iron and other metals. Moreover, the figures disclosed in this patent have shown a limited number of fitting types (90° elbows and reducing tees) for simplicity, yet the same principals apply equally well to 45° elbows, street ELLS, tees, couplings, and any other fitting type that is a potential failure point in a plumbing system. All such variations in pipe and fitting sizes, materials, and fitting types are deemed to be within the scope of the present invention. For example, the reducing tee shown in FIG. 9 is an example of a class of Repair Pipe Fittings that might include 45° elbows, 90° elbows, non-reducing tees, straight couplings and other fittings suitable for replacement of defective fittings in low-pressure systems.

Material or dimensional modification to increase strength or flexibility of the inlets and outlets is also anticipated. Flexible arms would facilitate repair, and it may prove possible to manufacture Repair Pipe Fittings from material similar to that used for flexible PVC pipe; although this is most likely possible only for non-pressurized portions of the plumbing system. Moreover, it is clearly possible to offer variations in the sizes of Repair Pipe Fittings to accommodate variation in the sizes of standard fittings. It is also possible to provide Repair Pipe Fittings to replace smaller Repair Pipe Fittings. Such modifications are obvious to anyone skilled in the art, and all such variations in dimensions and/or material are deemed to be within the scope of the present invention.

Alternate methods of sealing a Repair Pipe Fitting to connecting pipes are also anticipated. Just as it is possible to thread the arms of a Repair Fitting to accept caps and compression gaskets, thereby facilitating insertion in low pressure applications without glue, as shown in FIG. 9, other types of bonding may be facilitated by the inlet and outlet extension of Repair Pipe Fittings. Threaded, heat bonded, welded and all such connection variations that are made possible by the extension of the inlets and outlets on the Repair Pipe Fitting are deemed to be within the scope of the present invention.

1. A Repair Pipe Fitting suitable to replace an installed pipe fitting, where one or more of the arms on said Repair Pipe Fitting is of a longer length than the corresponding arm on said installed pipe fitting; said longer length being equal to the sum of the length of said corresponding arm of said installed pipe fitting and an additional length; said additional length being adequate to support a sealing method capable of creating a seal between said Repair Pipe Fitting and a pipe inserted into said Repair Pipe Fitting arm.

2. A Repair Pipe Fitting as in claim 1, where said Repair Pipe Fitting is manufactured from a plastic material, and said sealing method is bonding, gluing, cementing, welding or other method resulting in a permanent or semi-permanent connection.

3. A Repair Pipe Fitting as in claim 1, where said Repair Pipe Fitting is manufactured from a plastic material, and said sealing method uses bushings, o-rings, gaskets, threading or other method resulting in a non-permanent connection.

4. A Repair Pipe Fitting as in claim 1, where said Repair Pipe Fitting is manufactured from metal or metal alloy, and said sealing method uses mechanical pressure, threading, welding, or other method suitable for metal pipes and fittings.

5. A Repair Pipe Fitting as in claim 1, having pipe insertion stops set to limit pipe insertion into said Repair Pipe Fitting or to restrict movement of said Repair Pipe Fitting along said inserted pipe.

6. A Repair Pipe Fitting as in claim 1, having the outer diameter of one or more of the arms on said Repair Pipe Fitting threaded to accept a cap with an internal compression gasket, such that a seal may be made between said arm and a pipe inserted into said arm by compressing said gasket after insertion of said inserted pipe.
